(19) United States
(12) Patent Application Publication
(10) Pub. No.: US 2019/0369283 A1
(43) Pub. Date: Dec. 5, 2019

(54) CROSS-BORE DETECTION DURING HORIZONTAL DIRECTIONAL DRILLING

(71) Applicants: Vermeer Corporation, Pella, IA (US); Merlin Technology, Inc., Kent, WA (US)

(72) Inventors: David Hanson, Colbert, WA (US); Albert W. Chau, Woodinville, WA (US); Alan Wilson-Langman, Pleasant Hill, IA (US); Keith Sjostrom, Des Moines, IA (US); Kenneth J. Ryerson, Pella, IA (US)

(21) Appl. No.: 16/331,825

(22) PCT Filed: Sep. 7, 2017
(86) PCT No.: PCT/US17/50468

§ 371 Date: Mar. 8, 2019

Related U.S. Application Data
(60) Provisional application No. 62/385,522, filed on Sep. 9, 2016.
(60) Provisional application No. 62/398,072, filed on Sep. 22, 2016.

(51) Int. Cl. G01V 3/12; E21B 7/04; G01V 3/08; G01V 3/38; G01V 3/34; E21B 47/01

(52) U.S. Cl. CPC G01V 3/12; E21B 7/046; G01V 3/081; E21B 47/024; G01V 3/34; E21B 47/01; G01V 3/38

(57) ABSTRACT

An electromagnetic sensor is configured for deployment at or near a cutting tool connected to a drill string and moveable by a horizontal directional drilling machine. The sensor comprises a housing having an exterior surface which is exposed to soil when the drill string and cutting tool move through the soil. An antenna arrangement and a power source are supported by the housing. Circuitry is disposed in the housing and coupled to the power source and the antenna arrangement. The circuitry is configured to generate a signal for transmission by the antenna arrangement, measure a performance characteristic of the antenna arrangement using a power detector coupled to at least a transmit antenna of the antenna arrangement, and detect a change in the antenna performance characteristic relative to a threshold indicative of contact between the cutting tool and a buried utility.

### TECHNICAL FIELD

The present disclosure relates generally to the field of underground boring and, more particularly, to detecting a cross-bore during horizontal directional drilling using an electromagnetic sensor.

### BACKGROUND

Utility lines for water, electricity, gas, telephone, and cable television are often run underground. In many situations, the underground utilities can be buried in a trench which is then back-filled. Although useful in areas of new construction, the burial of utilities in a trench has certain disadvantages. In areas supporting existing construction, a trench can cause serious disturbance to structures or roadways. Further, there is a high probability that digging a trench may damage previously buried utilities, and that structures or roadways disturbed by digging the trench are rarely restored to their original condition. Also, an open trench poses a danger of injury to workers and passersby.

The general technique of boring a horizontal underground hole has recently been developed in order to overcome the disadvantages described above, as well as others unaddressed when employing conventional trenching techniques. In accordance with such a general horizontal boring technique, also known as horizontal directional drilling (HDD) or trenchless underground boring, a boring system is situated on the ground surface and drills a hole into the ground at an oblique angle with respect to the ground surface. A drilling fluid is typically flowed through the drill string, over the boring tool, and back up the borehole in order to remove cuttings and dirt. After the boring tool reaches a desired depth, the tool is then directed along a substantially horizontal path to create a horizontal borehole. After the desired length of borehole has been obtained, the tool is then directed upwards to break through to the earth's surface. A reamer is then attached to the drill string which is pulled back through the borehole, thus reaming out the borehole to a larger diameter. It is common to attach a utility line or other conduit to the reaming tool so that it is dragged through the borehole along with the reamer.

In general, trenchless excavation technologies, such as HDD, have the advantage of not being disruptive to the surface, yards, roads, driveways, traffic and trees, for example, but have the disadvantage of not allowing installers to actually see where utility lines are being installed.

A particularly concerning situation arises when a new utility is to be installed in a subsurface where an existing underground utility is located. In this scenario, a cross-bore may arise. A cross-bore is generally understood in the industry as an intersection of an existing underground utility or underground structure by a second utility resulting in direct contact between the transactions of the utilities that can compromise the integrity of either utility or underground structure.

By way of example, it sometimes occurs that a utility installation contractor using an HDD machine to install a gas service line inadvertently drills through or very near a main sewer or sewer lateral pipe and unknowingly installs a gas supply pipeline through or in contact with the sewer pipe. This direct or proximal unintended contact between underground utilities represents a cross-bore. At some later date when a back-up occurs in the sewer, the owner might engage a sewer cleaner using a cutter device to clear the sewer. This can lead to a breach in the gas line and subsequent ignition of the gas which flows into the sewer line.

### SUMMARY

Some embodiments are directed to a method comprising moving a drill string through the earth, the drill string having a terminal end comprising a cutting tool and an electromagnetic sensor at or proximate the cutting tool. The method comprises transmitting a signal from an antenna arrangement of the sensor into earth surrounding the terminal end of the drill string, the sensor comprising a power detector coupled to at least a transmit antenna of the antenna arrangement. The method also comprises measuring, using the power detector, a performance characteristic of the antenna arrangement to detect a change in antenna arrangement performance. The method further comprises detecting that the cutting tool has contacted a buried utility in response to comparing the change to a threshold.

Other embodiments are directed to an electromagnetic sensor configured for deployment at or near a cutting tool connected to a drill string. The sensor comprises a housing having an exterior surface which is exposed to soil when the drill string and cutting tool move through the soil. An antenna arrangement and a power source are supported by the housing. Circuitry is disposed in the housing and coupled to the power source and the antenna arrangement. The circuitry is configured to generate a signal for transmission by the antenna arrangement, measure a performance characteristic of the antenna arrangement using a power detector coupled to at least a transmit antenna of the antenna arrangement, and detect a change in the antenna performance characteristic relative to a threshold indicative of contact between the cutting tool and a buried utility. In some embodiments, the apparatus comprises a horizontal directional drilling machine configured to move the drill string, cutting tool, and electromagnetic sensor through earth.

Some embodiments are directed to a method comprising moving a drill string through the earth, the drill string having a terminal end comprising a cutting tool and an electromagnetic sensor at or proximate the cutting tool. The method comprises transmitting a signal from an antenna arrangement of the sensor into earth surrounding the terminal end of the drill string, the sensor comprising a power detector coupled to at least a transmit antenna of the antenna arrangement. The method also comprises measuring, using the power detector, a performance characteristic of the antenna arrangement to detect a change in antenna arrangement performance. The method further comprises detecting that the cutting tool has contacted a buried utility within a cross-bore zone in response to comparing the change to a threshold, and making additional performance characteristic measurements while moving the cutting tool into and out of the cross-bore zone. The method also comprises verifying contact between the cutting tool and the buried utility in response to comparing the additional performance characteristic measurements to the threshold.

Other embodiments are directed to a method comprising moving a drill string through the earth, the drill string having a terminal end comprising a cutting tool and an electromagnetic sensor at or proximate the cutting tool. The method comprise transmitting a signal from an antenna arrangement of the sensor into earth surrounding the terminal end of the drill string, the sensor comprising a power detector coupled to at least a transmit antenna of the antenna arrangement. The method also comprises measuring, using the power detector, a performance characteristic of the antenna arrangement to detect a change in antenna arrangement performance. The method comprises detecting that the cutting tool has contacted a buried utility in response to comparing the change to a plurality of thresholds. The method also comprises generating, at the sensor, an alert signal and a confidence level indicator in response to the change exceeding one or more of the plurality of thresholds. The method further comprises transmitting the alert signal and the confidence level indicator to an above-ground device.

The above summary is not intended to describe each disclosed embodiment or every implementation of the present disclosure. The figures and the detailed description below more particularly exemplify illustrative embodiments.

### BRIEF DESCRIPTION OF THE DRAWINGS

FIG. 1 is a flow chart of a method of detecting contact between a subsurface cutting tool and a buried utility using an EM sensor in accordance with various embodiments;

FIG. 2 is a flowchart of a method of detecting contact between a subsurface cutting tool and a buried utility using an EM sensor in accordance with various embodiments;

FIG. 3 is a flow chart of the method of detecting contact between a subsurface cutting tool and a buried utility using an EM sensor in accordance with various embodiments;

FIG. 4 shows an apparatus for detecting contact between a subsurface cutting tool and a buried utility using an EM sensor in accordance with various embodiments;

FIG. 5A shows an EM sensor comprising a transmit antenna and a receive antenna, the EM sensor adapted for detecting contact between a subsurface cutting tool and a buried utility (e.g., a cross-bore) in accordance with various embodiments;

FIG. 5B illustrates an EM sensor which includes a single antenna, the EM sensor adapted for detecting contact between a subsurface cutting tool and a buried utility (e.g., a cross-bore) in accordance with various embodiments;

FIG. 5C illustrates a section of a drill string which includes a sonde housing configured to receive a sensor package comprising an the EM sensor adapted for detecting contact between a subsurface cutting tool and a buried utility (e.g., a cross-bore) in accordance with various embodiments;

FIG. 5D is a cross-sectional view of the sensor package shown in FIG. 5C;

FIG. 5E shows four pairs of antennas of an EM sensor situated at 12:00, 3:00, 6:00 and 9:00 positions of a drill string or sonde/sub in accordance with various embodiments;

FIG. 5F shows four single antennas of an EM sensor situated at 12:00, 3:00, 6:00 and 9:00 positions of a drill string or sonde/sub in accordance with various embodiments;

FIG. 6 shows a receive antenna separated from a transmit antenna by intervening soil/surrounding materials in accordance with various embodiments;

FIG. 7 is a graph showing detection of an underground void using an EM sensing technique in accordance with various embodiments;

FIG. 8A shows a hollow 12-inch diameter aluminum sphere that was buried in sandy soil and struck by a drill head equipped with an EM sensing capability in accordance with various embodiments;

FIG. 8B is data showing a large change in coupled antenna power of an EM sensor of the present disclosure in response to penetrating the sphere shown in FIG. 8A;

FIG. 9A shows an 8-inch diameter PVC air-filled pipe that was buried in sandy soil and struck by a drill head equipped with an EM sensing capability in accordance with various embodiments;

FIG. 9B is data showing a large change in coupled antenna power of an EM sensor of the present disclosure in response to striking, but not penetrating, the pipe shown in FIG. 9A;

FIG. 9C is data showing a large change in coupled antenna power in response to penetration of a 3-inch diameter water-filled PVC pipe buried in damp clay by a drill head equipped with an EM sensing capability in accordance with various embodiments;

FIG. 10A shows reflection (S11) data acquired from an EM sensor of a drill head for different scenarios of contact or near-contact between the drill head and different pipes and a void in accordance with various embodiments;

FIG. 10B shows coupling (S21) data acquired from an EM sensor of a drill head for different scenarios of contact or near-contact between the drill head and different pipes and a void in accordance with various embodiments;

FIG. 11A shows a cross-section through a portion of ground where a boring operation takes place using an HDD machine equipped with an EM sensor configured to detect contact with and/or penetration of an underground utility (e.g., a cross-bore) according to various embodiments; and

FIG. 11B shows a display of the HDD machine of FIG. 11A configured to present a cross-bore alert in response to data received from an EM sensor provided at or proximate a drill head in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description of the illustrated embodiments, references are made to the accompanying drawings forming a part hereof, and in which are shown by way of illustration, various embodiments by which the invention may be practiced. It is to be understood that other embodiments may be utilized, and structural and functional changes may be made without departing from the scope of the present invention.

Systems, devices or methods according to the present invention may include one or more of the features, structures, methods, or combinations thereof described herein. For example, a device or system may be implemented to include one or more of the advantageous features and/or processes described below. It is intended that such a device, system or method need not include all of the features described herein, but may be implemented to include selected features that provide for useful structures, systems, and/or functionality.

Embodiments are directed to an electromagnetic (EM) sensor comprising an antenna arrangement and circuitry configured to detect changes in one or more antenna performance characteristics indicative of contact between or penetration of a buried utility. Embodiments are directed to an EM sensor configured to detect a cross-bore in response to a change in one or more antenna performance characteristics. Embodiments are directed to an EM sensor configured for deployment at or near the distal end of a drill string, such as drill string driven by a Horizontal Directional Drilling (HDD) machine.

Horizontal Directional Drilling is a process that provides a number of benefits for installing buried/underground utilities. There are also a number of hazards associated with the process. As previously discussed, one recognized hazard is the potential for cross-bores, situations where a bore hole intersects an existing utility. Such an intersection results in direct contact between the transactions of the utilities that compromises the integrity of either utility or underground structure. This can occur in a way that it is not apparent that an intersection has occurred during the installation process, which can result in hazards that play-out later. The safety considerations related to cross-bores has resulted in the formation of an association to raise the awareness of the potential occurrence, and to communicate best practices to avoid the occurrence, the Cross Bore Safety Association (CBSA). Cross-bores can occur when a bore hole intersects a sewer line, either a lateral or a main line. The CBSA has identified this scenario as the initial priority in a statement: “The association agrees that the initial focus will be to address cross-bores where natural gas lines intersect sewer lines.” The CBSA recognizes that other types of cross-bores are also possible.

There is a need within industry for a cross-bore detection system, based on the assumption that this system would be more cost effective than an avoidance system like a drill head radar system. The goal of a cross-bore detection system is different than drill head radar systems. For example, the goal of a cross-bore detection system is to detect that an intersection has occurred. In contrast, avoidance systems (e.g., drill head radar systems) are intended to provide information to the driller so that they can avoid an intersection, where a potential intersection is identified far enough in advance that the drill path can be modified to avoid the intersection altogether.

Development work on drill head radar systems has been directed at providing an advance warning to the operator that an obstacle/utility is being approached. Radar systems currently being developed are close to achieving this goal, but they are relatively complex systems, requiring sophisticated processing to provide automated obstacle detection. The complexity of the radar systems is at least partially influenced by the goal of providing information adequate for the systems to be used to avoid intersections.

However, if just knowing that a cross-bore has occurred has value, this can be achieved by making various electromagnetic measurements using an EM sensor of the present disclosure. For example, whenever the media surrounding an antenna of the EM sensor changes, this impacts how the antenna performs. Effects range from a large near-field reflection caused by the property change, to changes in coupling between antennas, to how well energy is coupled from the antenna to the media.

When an air-filled void such as a sewer is struck, for example, the receiving antenna of the EM sensor records a large amplitude bloom from the change in permittivity between the soil and void. This is readily detectable, and requires no special training to identify. Thus, an EM sensor of relatively low complexity can be used to indicate when a lateral (or void) has been penetrated. The same type of behavior is seen when the target is not hollow—as long as it is of sufficient size and EM contrast to impact the electrical properties of the surrounding soil.

Radar systems, such a ground penetration radar (GPR), are complex and expensive systems used to detect subsurface objects spaced apart from the radar using return signals, but not to detect direct contact with or penetration of a buried object. As such, conventional radar systems are not used to detect cross-bores. Embodiments of the disclosure are directed to an EM sensor of relatively low complexity and techniques for assessing information about the power radiating properties of an antenna or antennas, which provides the capability of reliably detecting when a drilling/boring device has actually intersected a sewer lateral.

As previously discussed, a radar sensor is complex and expensive, so an alternative sensor of reduced complexity is desirable. An EM sensor implemented in accordance with the present disclosure can be configured to detect cross-bores and contact with or penetration of other buried structures using a number of techniques, including measuring: 1) the direct coupling level between antennas; 2) the near-field signal amplitude recorded as a lateral is struck; and/or 3) the reflection coefficient at the antenna (S11 or VSWR). It should be understood that none of these approaches involve a radar per se, as no imaging or reflected signals are used (e.g., no reflected signal is measured, nor is range data available). Each of these techniques is dependent on the change in the surrounding media impacting antenna performance.

In the first case, a change in the magnitude of the direct coupling signal between the transmitting and receiving antennas occurs as the material surrounding the antennas changes. For example, a factor of 10 change in direct coupling signal amplitude has been observed when the antennas are in soil versus when they are in air. Thus, a large change in direct coupling will occur when the drill head passes from soil to a partially air-filled lateral. This approach is attractive since, according to some embodiments, complex processing of the data is not required (e.g., the raw amplitude of the received signal can be displayed).

Also, if a processing step is applied where the direct coupling signal is removed, the change in permittivity at the utility will result in a large amplitude signal that can be readily detected. Finally, the degree to which energy is coupled into the soil is a function of the dielectric of the soil surrounding the antenna. If this changes, the electrical matching of the antenna will change, resulting in a change of the S11 (or VSWR) parameter. Again, this requires rudimentary processing to detect, and can be simply presented to the operator as an alert. A deviation from a miming average can indicate penetration of a gas- or water-filled utility, for example.

Embodiments of an EM sensor according to the present disclosure provide significant advantages over a radar sensor approach. First, EM sensors of the disclosure can be of relatively low complexity and less expensive than a radar sensor. The hardware for some embodiments of the EM sensor can be at least an order of magnitude less expensive than the full radar. Second, since all that is required is the amplitude of the near-field signal, no sophisticated processing is needed. Third, no imaging is performed, so signal penetration distance is not an issue. Finally, and perhaps most importantly, the EM sensing technique of the present disclosure is soil independent. For example, EM sensors of the disclosure can be used in the entire range of soils from sands to heavy clay.

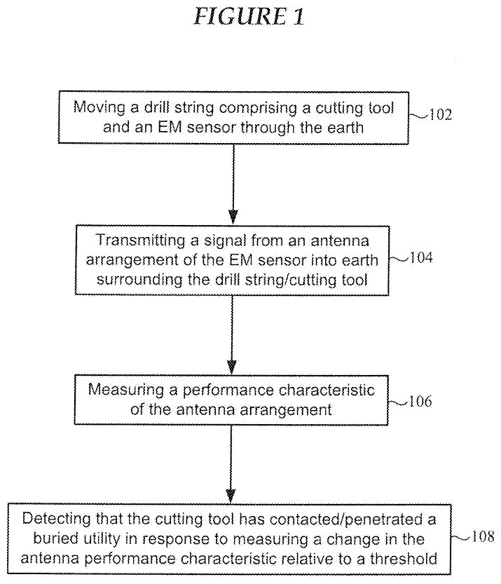

FIG. 1 is a flow chart of a method of detecting contact between a subsurface cutting tool (e.g., a drill head) and a buried utility in accordance with various embodiments. The method shown in FIG. 1 involves moving 102 a drill string comprising a cutting tool and an EM sensor through the earth. The method involves transmitting 104 a signal from an antenna arrangement of the EM sensor into earth surrounding the drill string and/or cutting tool. The method also involves measuring 106 a performance characteristic of the antenna arrangement while the EM sensor is moving through the earth. The method further involves detecting 108 that the cutting tool has contacted and/or penetrated a buried utility in response to measuring a change in the antenna performance characteristics relative to a threshold. For example, a cross-bore can be detected by measuring a change in the antenna performance characteristics relative to a threshold.

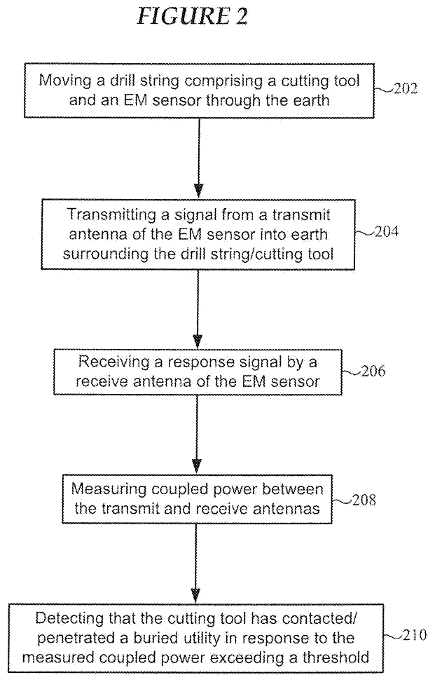

FIG. 2 is a flowchart of a method of detecting contact between a subsurface cutting tool and a buried utility in accordance with various embodiments. The method shown in FIG. 2 involves moving 202 a drill string comprising a cutting tool and an EM sensor through the earth. The method involves transmitting 204 a signal from a transmit antenna of the EM sensor into earth surrounding the drill string and/or cutting tool. The method involves receiving 206 a response signal by a receive antenna of the EM sensor. The method also involves measuring 208 coupled power between the transmit and receive antennas. The method further involves detecting 210 that the cutting tool has contacted or penetrated a buried utility in response to the measured coupled power exceeding a threshold. For example, a cross-bore can be detected by measuring a change in the coupled power relative to a threshold.

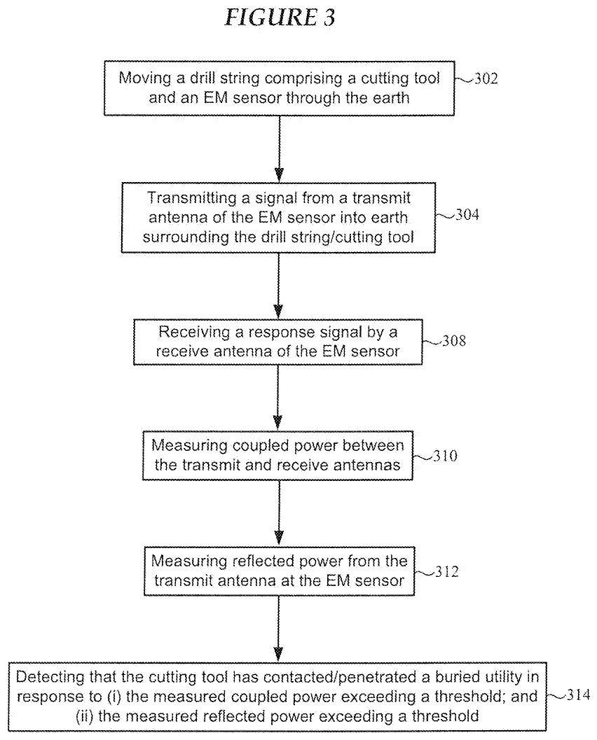

FIG. 3 is a flow chart of the method of detecting contact between a subsurface cutting tool and a buried utility in accordance with various embodiments. The method shown in FIG. 3 involves moving 302 a drill string comprising a cutting tool and an EM sensor through the earth, and transmitting 304 a signal from the transmit antenna of the EM sensor into earth surrounding the drill string and/or cutting tool. The method also involves receiving 308 a response signal by a receive antenna of the EM sensor, and measuring 310 coupled power between the transmit and receive antennas. The method further involves measuring 312 reflected power from the transmit antenna at the EM sensor. The method also involves detecting 314 that the cutting tool has contacted or penetrated a buried utility in response to (i) the measured coupled power exceeding a threshold; and (ii) the measured reflected power exceeding a threshold. For example, a cross-bore can be detected by measuring a change in the coupled power and the measured reflected power relative to respective thresholds. It is noted that, according to some embodiments, contact between the cutting tool and a buried utility (e.g., a cross-bore) can be detected in response to the measured reflected power exceeding a threshold without considering coupled antenna power.

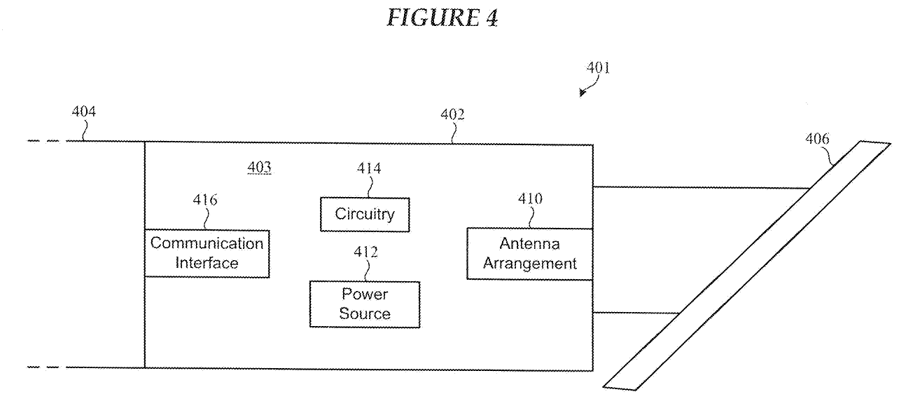

FIG. 4 shows an apparatus for detecting contact between a subsurface cutting tool and a buried utility in accordance with various embodiments. The apparatus shown in FIG. 4 includes an electromagnetic sensor 402 incorporated in a cutting tool 401 of an underground drilling apparatus. In some embodiments, the electromagnetic sensor 402 is incorporated in a backreamer, such that utilities not detected or hit on the pilot bore can be detected if they are intersected on the backream. According to various embodiments, the cutting tool 401 is a component of a horizontal directional drilling (HDD) apparatus. The cutting tool 401 is configured to be connected to a drill string 404 on one end and includes a cutting spade 406 on the other end. As shown, the EM sensor 402 is configured for deployment at or near the cutting tool 401. The EM sensor 402 is shown deployed behind the cutting spade 406 of the cutting tool 401. In some embodiments, the EM sensor 402 is deployed on the drill string 404 behind the cutting tool 401. For example, the EM sensor 402 can be incorporated in a sonde or sub that is connected or integral to the drill string 404.

The EM sensor 402 includes a housing 403 having an exterior surface which is exposed to soil when the drill string 404 and cutting tool 401 move through the soil. The EM sensor 402 includes an antenna arrangement 410 supported by the housing 403. In some embodiments, the antenna arrangement 410 includes a single transmit antenna, but preferably includes a transmit antenna and a receive antenna. According to some embodiments, the transmit antenna and/or receiver antenna are disposed on the housing 403 and exposed to the soil. The housing 403, for example, can include slots within which the transmit and/or receive antennas are mounted so as to minimize damage to the antennas while exposing antennas to the soil. In other embodiments, the transmit and/or receive antennas (e.g., small patch antennas) are positioned on or in the housing 403 behind EM-permissive windows (e.g., ceramic windows).

A power source 412 is disposed in the housing 403 and provides power to the various components of the EM sensor 402. Circuitry 414 is disposed in the housing 403 and coupled to the power source 412 and the antenna arrangement 410. The circuitry 414 is configured to generate a signal for transmission by the antenna arrangement 410 and measure a performance characteristic of the antenna arrangement 410. The circuitry 414 is also configured to detect a change in the antenna performance characteristic relative to a threshold indicative of contact between the cutting tool 401 (e.g., the cutting spade 406) and a buried utility (e.g., a cross-bore).

The circuitry 414 includes memory for storing the antenna performance characteristics that are acquired while advancing the EM sensor 402 through the subsurface. The memory can also store one or more thresholds used by the circuitry 414 to detect a contact/penetration event with a buried utility. A communication interface 416 is configured to transmit data from the EM sensor 402 to an external system or device. For example, data stored in the memory of the circuitry 414 can be communicated to an external system, device, or transmission medium via the communication interface 416. In some embodiments, antenna performance characteristics are acquired while drilling or backreaming through the earth, time stamped at regular intervals (e.g., every 0.1-10 seconds), and stored in the memory of the circuitry 414. Time stamping the EM sensor data allows the EM sensor data to be associated (e.g., time synchronized) with positioning data (e.g., encoder data, GPS data or extrapolated positioning data based on GPS and encoder data) generated by an above-ground system or device, such as the drilling machine and/or a portable locator equipped with a GPS sensor, for example.

After the EM sensor 402 emerges from the subsurface, for example, data stored in the memory can be transferred out of the EM sensor 402 via the communication interface 416. In some embodiments, the communication interface 416 is configured to provide wireless communication between the EM sensor 402 and an external system or device (e.g., a receiver of a portable locator). For example, a handheld locator can be configured to receive cross-bore data produced by the EM sensor 402 and sonde data (for drill head position, roll angle, and pitch) via an RF link. These data can be transmitted from the handheld locator to a console of an HDD operator station. The cross-bore data can be displayed along with other drill head information on a display of the HDD operator station. In other embodiments, the communication interface 416 includes a hardwire connector, which can be connected to a corresponding connector of a transmission cable or device. In further embodiments, the communication interface 416 is configured to communicate EM sensor data in real time or near-real time to a processor of a drilling machine via a conductor or transmission path established along the drill string 404 (e.g., through coupled conductors running through the drill pipes).

In some embodiments, the antenna arrangement 410 includes a transmit antenna, and the performance characteristic comprises reflected power from the transmit antenna as measured by the circuitry 414. In other embodiments, the antenna arrangement 410 includes a transmit antenna and a receive antenna, and the performance characteristic comprises power coupled between the transmit antenna and the received antenna. In further embodiments, a number of different antenna performance characteristics are measured by the circuitry 414, and contact between the cutting tool 401 and a buried utility is detected in response to measuring a change in each of the antenna performance characteristics relative to a respective threshold.

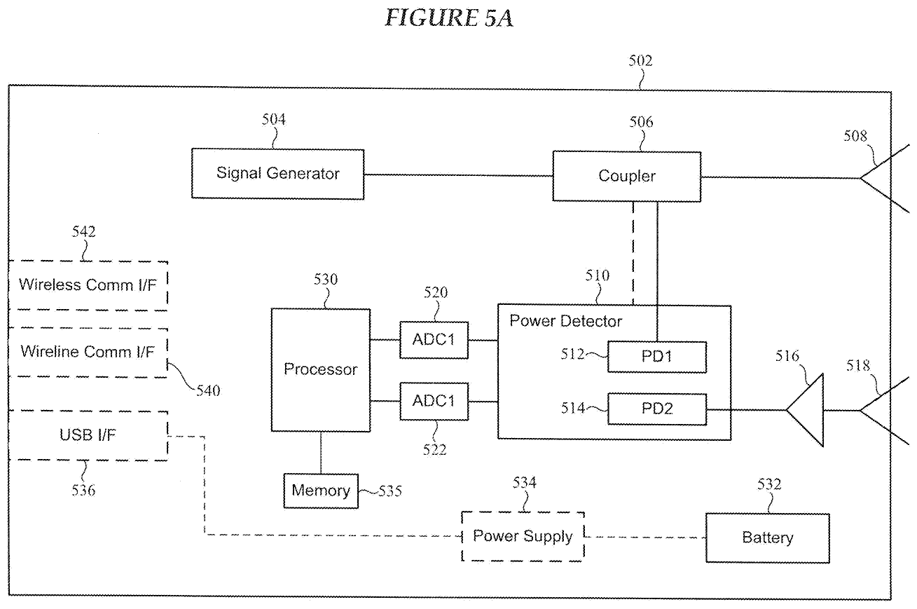

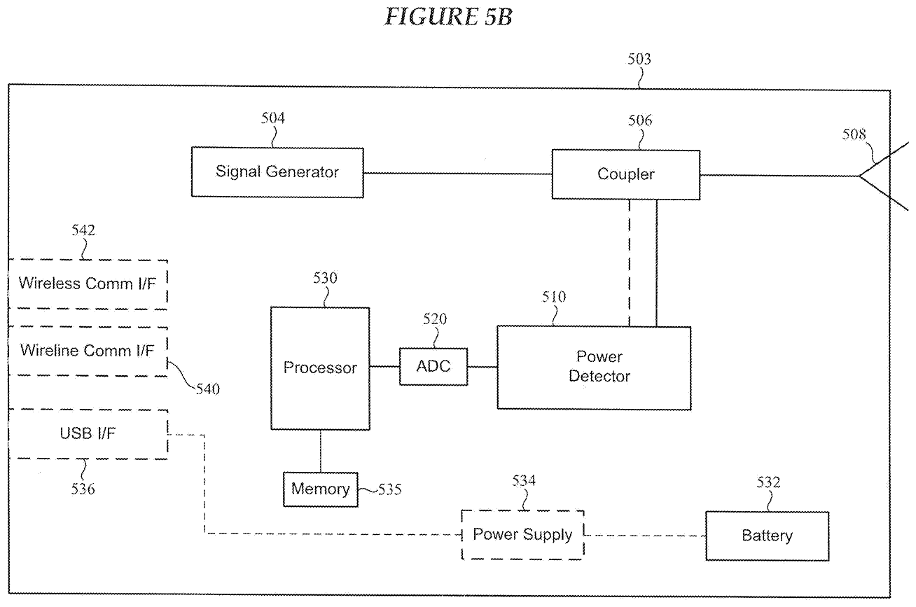

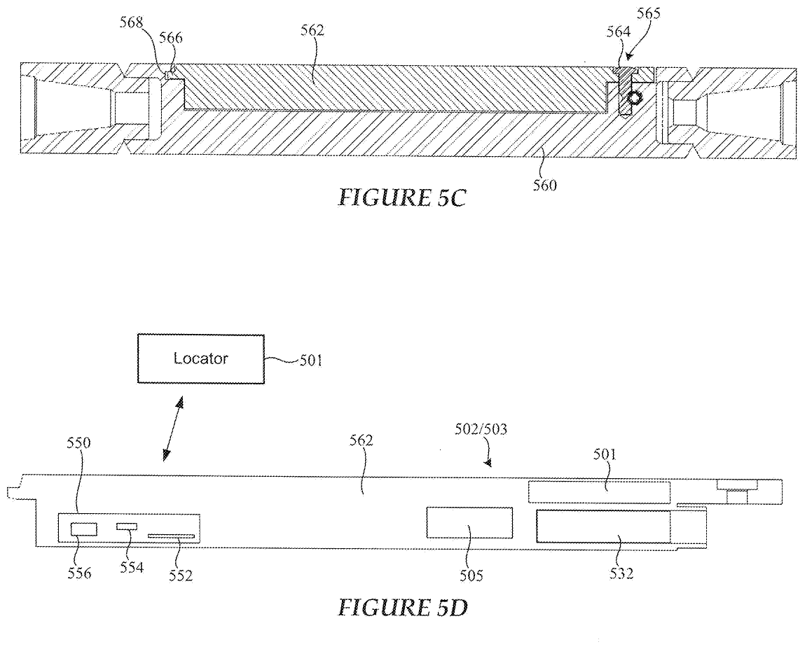

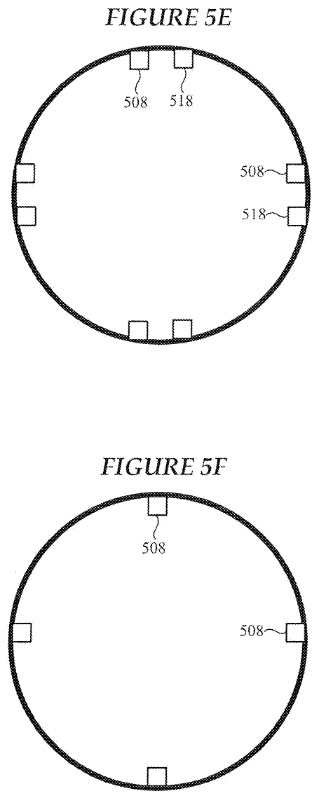

FIG. 5A shows an EM sensor 502 adapted for detecting contact between a subsurface cutting tool and a buried utility (e.g., a cross-bore) in accordance with various embodiments. The EM sensor 502 shown in FIG. 5A can be incorporated in a cutting tool or a drill string sonde or sub proximate the cutting tool of an underground drilling (e.g., HDD) apparatus. The EM sensor 502 includes a signal generator 504, a transmit antenna 508, and a receive antenna 518. The signal generator 504 is coupled to the transmit antenna 508 via a coupler 506. Reflected energy received at the transmit antenna 508 is coupled to a power detector 510 via the coupler 506. The signal generator 504 (e.g., a PPL or oscillator) is configured to generate a radio frequency signal, such as a continuous wave (CW) sine wave, having a frequency between about 500 MHz and 3 GHz. In some embodiments, the signal generator 504 can generate an RF signal having a frequency in the range of about 800 MHz to about 1.6 GHz. In other embodiments, the signal generator 504 can generate an RF signal having a frequency in the range of about 1.7 GHz to about 2.4 GHz (e.g., a 2.4 GHz Wi-Fi® signal).

In general, a frequency between about 500 MHz and 3 GHz can be used. However, the exact limits of the frequency ranges, or exactly what frequencies give the best response for particular cross-bore types can be determined via experimentation. It is possible, for example, that different frequencies will provide better information on metallic or non-metallic utilities, or different sized utilities, or on different fill materials.

Notably, the transmit and receive antennas 508 and 518 can be less complex than those used in conventional ground penetrating radar applications. Because only near-field effects impacting the performance characteristics of the antennas 508 and 518 are measured by the EM sensor 502, there is no need to propagate a signal a distance through the earth or to perform any imaging as is the case when using GPR. Accordingly, small, high-frequency antennas in the 2 GHz range, for example, can be used. As was discussed previously, the transmit and receive antennas 508 and 518 can be slot antennas that are machined into the housing of a sonde or sub of the drill string. It is preferred that the antennas 508 and 518 not be mounted on the drill spade directly, but are better placed on the drill shaft behind the drill spade or other cutting surface of the cutting tool. As such, wear and stress on the EM sensor components are reduced, allowing the EM sensor 502 to be used in demanding applications. For example, the EM sensor 502 can be used with a rock drill.

In some embodiments, the EM sensor 502 includes one pair of transmit and receive antennas 508 and 518. In other embodiments, the EM sensor includes a multiplicity of transmit and receive antenna pairs. For example, and as shown in FIG. 5E, one pair of transmit and receive antennas 508 and 518 can be positioned at a 12:00 location of the drill string or sonde/sub. A second pair of transmit and receive antennas 508 and 518 can be positioned at the 6:00 location of the drill string or sonde/sub. In another example, a pair of transmit and receive antennas 508 and 518 can be positioned at 12:00, 3:00, 6:00 and 9:00 positions of the drill string or sonde/sub. In embodiments that use multiple pairs of transmit and receive antennas 508 and 518, each antenna pair can be coupled to its own power detector 510, coupler 506, and ADCs 520 and 522. It is understood that two antenna pairs at 12:00 and 6:00 positions are contemplated.

As was discussed above, the transmit antenna 508 is coupled to the power detector 510 via the coupler 506. Suitable power detector components include the AD8302 from Analog Devices, the MAX2016 and MAX2112 from Maxim Integrated Products, and the LTC5583 from Linear Technology. The power detector 510 is also coupled to the receive antenna 518. In some configurations, an amplifier 516 (e.g., a 10 dB amplifier) can be coupled between the receiver antenna 518 and the power detector 510. In the embodiment shown in FIG. 5A, the power detector 510 includes the first power detector 512 coupled to the transmit antenna 508 (via the coupler 506) and a second power detector 514 coupled to the receive antenna 518 (via the amplifier 516). The first power detector 512 is configured to detect reflected power from the transmit antenna 508. The second power detector 514 is configured to detect coupled power between the transmit and receive antennas 508 and 518.

It is noted that the EM sensor 502 measures the coupling and reflection coefficients relative to the transmit power from the signal source (e.g., signal generator 504). As such, one of the power detectors 512, 514 is always connected to a coupled version of the (forward) transmit power (e.g., via the dashed-line connection between the coupler 506 and the power detector 510). EM sensor 502 then switches the second channel between the coupled received power and the reflected transmit power. In this way the measurements are always relative to the transmit power, hence removing the effects of variation of transmitter power for the EM sensor 502 allowing the measured data to be independent of the transmitter.

The first power detector 512 is coupled to a first ADC (analog-to-digital converter) 520, and the second power detector 514 is coupled to a second ADC 522. A processor 530, such as a microprocessor, is coupled to the first and second ADCs 520 and 522. The processor 530 is coupled to memory 535. The memory 535 is configured to store various data, including various thresholds. In some embodiments, the processor 530 receives digitized signals from the first and second ADCs 520 and 522 and compares these data against respective thresholds stored in the memory 535. For example, a first threshold can be established based on reflected power for the transmit antenna 508. A second threshold can be established based on coupled power for the transmit and receive antennas 508 and 518. As the EM sensor 502 advances through soil, normal reflected power and coupled power signals are output from the first and second power detectors 512 and 514. These normal signals have some nominal variation due to the heterogeneous nature of the soil surrounding the EM sensor 502.

The first threshold can be based on a deviation (e.g., >a 5 sigma variation) in the normal reflected power signal at the output of the first power detector 512 indicative of contact with or penetration through a buried utility. The second threshold can be based on a deviation (e.g., >a 5 sigma variation) in the normal coupled power signal at the output of the second power detector 514 indicative of contact with or penetration through a buried utility. In embodiments that employ only a transmit antenna 508 (no receive antenna 518), contact between the cutting tool/EM sensor 502 and the buried utility can be detected in response to the signal output from the second power detector 514 exceeding the second threshold (e.g., in which case the first power detector 512 and ADC 520 need not be included). In embodiments that use both the transmit antenna 508 and receive antenna 518, contact between the cutting tool/EM sensor 502 and the buried utility detected using the second threshold can be corroborated (e.g., validated) by the signal output from the first power detector 512 exceeding the first threshold.

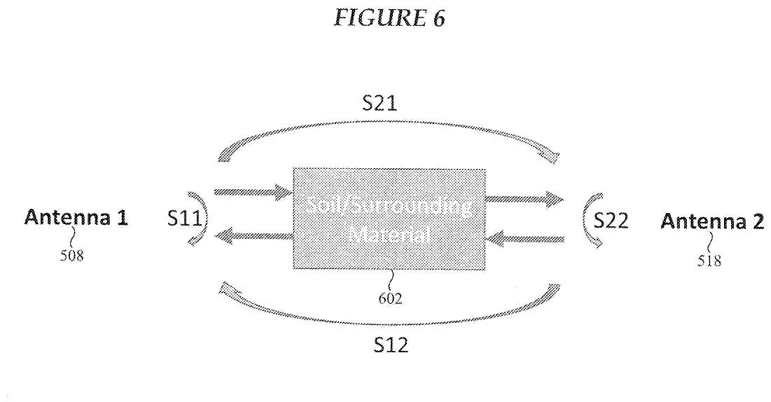

Referring to FIG. 6 in addition to FIG. 5A, the input-output power relationship between the receive antenna 508 and transmit antenna 518 is depicted in terms of S-parameters. FIG. 6 shows the receive antenna 508 separated from the transmit antenna 518 by intervening soil/surrounding materials 602. The S-parameters shown in FIG. 6 describe how much power is coupled between the antennas 508 and 518 and how much power is reflected back at the antenna terminals. In the context of FIG. 6, the primary S-parameters of interest are the parameters S11 and S21, since one of the antennas is a dedicated transmit antenna (antenna 508) and one of the antennas is a dedicated receive antenna (antenna 518). The parameter S11 represents the amount of power reflected from the transmit antenna 508 (and seen by the first power detector 512), sometimes referred to as the reflection coefficient or return loss. The parameter S21 represents the power received at the receive antenna 518 (and seen by the second power detector 514) relative to the power input to the transmit antenna 508.

Changes in the media surrounding the antennas 508 and 518 result in changes in coupled power (e.g., S21) and also antenna resonant frequencies. Changes in the media surrounding the transmit antenna 508 results in changes in reflected power (e.g., S11). For example, changes in the coupled power between the transmit and receive antennas 508 and 518 (e.g., S12) can indicate an intersected or nearby utility. These changes in coupled power and reflected power can be compared to thresholds by the processor 530 in order to detect whether a cutting tool has contacted and/or penetrated a buried utility (e.g., a cross-bore).

Referring again to FIG. 5A, the memory 535 can store contact/penetration event data produced by the processor 530 and/or raw power detector data produced by the power detector 510. In preferred embodiments, the processor 530 is configured to analyze raw power detector data received from the power detector 510 in real-time (downhole) and detect contact/penetration events in real-time. In a less complex implementation, for example, the processor 530 stores raw power detector data in the memory 535 during a drilling/backreaming operation, but is not configured to detect contact/penetration events. Rather, an above-ground processor (e.g., laptop, tablet, drilling machine computer, locator) receives the raw power detector data from the memory 535 after the cutting tool emerges from the subsurface, and performs contact/penetration analysis on the raw power detector data.

The EM sensor 502 includes a battery 532 which provides power to the various electrical and electronic components of the EM sensor 502. In some embodiments, power for the EM sensor 502 can be drawn from a power conductor built into the drill string rather than from a battery. The EM sensor 502 may include one or more communication interfaces, three of which are shown in the representative embodiment of FIG. 5A. It is understood that the EM sensor 502 need not include each of the three interfaces shown in FIG. 5A. The EM sensor 502 may include a USB interface 536 which receives power from a power supply 534 coupled to the battery 532. The USB interface 536 can be used to transfer time-stamped antenna performance characteristics data from the memory 535 to an external device or system. The USB interface 536 can also be used to access the processor 530 for purposes of programming, updating, and debugging the EM sensor 502.

The EM sensor 502 may include a wireline communication interface 540 configured to effect communications between the EM sensor 502 and a wireline provided by or built into the drill string. The wireline communication interface 540 facilitates near real-time transfer of antenna performance characteristics data to an above-ground system or device during drilling/backreaming operations. The EM sensor data acquired in near real-time can be combined with location data produced by an encoder of the drilling machine or by GPS measurements made by a portable locator (or both encoder and GPS measurements). Utility strikes and cross-bores can be detected and the locations of these events identified in near real-time.

The EM sensor 502 may include a wireless communication interface 542 (e.g., Wi-Fi®, Bluetooth®, ZigBee®, 802.11) configured to effect wireless communications between the EM sensor 502 and an above-ground wireless system or device. As was discussed previously, EM sensor data can be stored in the memory 535 of the EM sensor 502 while underground, and when returning to ground level, can wirelessly download the data to a separate system or device. For example, EM sensor data can be stored in the memory 535 while the EM sensor 502 is underground, and the EM sensor data can be downloaded via Wi-Fi® after the drill string emerges from the subsurface. A distance measurement can be made using an encoder on the drilling machine which provides distance along the bore. The distance measurement data can be synchronized with the EM sensor data after the download. An application running on a smart phone, tablet or a computer, for example, can display the associated EM sensor and position data on a display.

According to another embodiment, the wireless communication interface 542 can include a Bluetooth® device configured to enable a communication link between the EM sensor 502 and an above-ground portable locator when the drill string emerges from underground. The data transferred from the EM sensor 502 to the locator can then be communicated to the electronic system of the drilling machine where it can be combined in a machine database that includes time-stamped position (e.g., footage) data. Combining the EM sensor data with position data allows for relatively accurate locating of a cross-bore when detected by the EM sensor 502.

FIG. 5B illustrates an EM sensor 503 which includes a single antenna 508 in accordance with various embodiments. The EM sensor 503 shown in FIG. 5B is a less complex EM sensor in that the antenna arrangement includes a single antenna 508 rather than separate transmit and receive antennas as in the case of the embodiment shown in FIG. 5A. The EM sensor 503 shown in FIG. 5B can be used to detect contact between a subsurface cutting tool and a buried utility (e.g., a cross-bore), and be incorporated in a cutting tool or a drill string sonde or sub proximate the cutting tool of an underground drilling (e.g., HDD) apparatus. The EM sensor 503 shown in FIG. 5B is configured to operate in a manner similar to the EM sensor 502 shown in FIG. 5A, but operates on reflected energy received by the antenna 508 rather than on coupled power between a transmit antenna and a receive antenna. Changes in the media surrounding the antenna 508 result in changes in reflected power (e.g., S11). These changes in reflected power can be compared to a threshold by the processor 530 in order to detect whether a cutting tool has contacted and/or penetrated a buried utility (e.g., a cross-bore).

The EM sensor 503 includes a signal generator 504 coupled to the antenna 508 via a coupler 506. Reflected energy received at the antenna 508 is coupled to a power detector 510 via the coupler 506. The power detector 510 is always connected to a coupled version of the (forward) transmit power (e.g., via the dashed-line connection between the coupler 506 and the power detector 510). The signal generator 504 (e.g., a PPL or oscillator) is configured to generate a radio frequency signal, such as a continuous wave (CW) sine wave, having a frequency between about 500 MHz and 3 GHz (e.g., see the subranges discussed hereinabove). Although a single antenna 508 is shown in FIG. 5B, the EM sensor 503 can include a multiplicity of single antennas 508 positioned at spaced-apart locations around the circumference of the sonde/sub. In FIG. 5F, for example, four antennas 508 are shown positioned at 12:00, 3:00, 6:00 and 9:00 positions of the drill string or sonde/sub. In such embodiments, each antenna 508 would be coupled to its own power detector 510, coupler 506, and ADC 520. It is understood that two antennas 508 at 12:00 and 6:00 positions are contemplated.

The power detector 510 is coupled to the ADC 520, and a processor 530 is coupled to the ADC 520. The processor 530 is coupled to memory 535. As was discussed previously, the memory 535 is configured to store various data, including various thresholds (e.g., a 5 sigma variation in the normal reflected power signal). In some embodiments, the processor 530 receives digitized signals from the ADC 520 and compares these data against a threshold stored in the memory 535. As the EM sensor 503 advances through soil, reflected power signals are output from the power detector 510 and compared to a threshold by the processor 503. Contact between the cutting tool/EM sensor 503 and the buried utility can be detected in response to the signal output from the power detector 510 exceeding the threshold.

As was previously discussed, the memory 535 can store contact/penetration event data produced by the processor 530 and/or raw power detector data produced by the power detector 510. In preferred embodiments, the processor 530 is configured to analyze raw power detector data received from the power detector 510 in real-time (downhole) and detect contact/penetration events in real-time. In a less complex implementation, for example, the processor 530 stores raw power detector data in the memory 535 during a drilling/backreaming operation, but is not configured to detect contact/penetration events. Rather, an above-ground processor (e.g., laptop, tablet, drilling machine computer, locator) receives the raw power detector data from the memory 535 after the cutting tool emerges from the subsurface, and performs contact/penetration analysis on the raw power detector data.

The EM sensor 503 includes a battery 532 which provides power to the various electrical and electronic components of the EM sensor 503. In some embodiments, power for the EM sensor 503 can be drawn from a power conductor built into the drill string rather than from a battery. As was previously discussed, the EM sensor 503 may include one or more communication interfaces, three of which are shown in the representative embodiment of FIG. 5B, it being understood that the EM sensor 503 need not include each of the three interfaces shown in FIG. 5B. Time-stamped EM sensor data can be combined with distance measurement data for the bore, so that associated EM sensor and position data can be used to accurately locate and display a cross-bore when detected by the EM sensor 503.

In accordance with other embodiments, the EM sensors 502 and 503 can be integrated with other sensors and sources that can provide additional information, thus increasing the confidence that a utility strike or cross-bore has occurred. Complementary sensors and information can include: fluid pressure, HDD thrust, HDD torque, bore advance rate, single point resistance logging, self potential logs, normal resistivity logs, EM logging using the sonde frequency, and temperature logging. Any of these additional sensors and information sources can be fused with EM sensor data to increase the confidence in a utility strike or cross-bore alert. Using these additional sensors and information can reduce false alarms and false positive detections.

FIGS. 5C and 5D show a section of a drill string that incorporates an EM sensor of a type previously described in accordance with various embodiments. The section of the drill string shown in FIGS. 5C and 5D includes a sonde housing 560 which is configured to receive a sensor package 562. The sensor package 562 can be implemented as a panel having a tongue 566 on one end and a bolt hole 565 through a lip on the other end. The sensor package 562 is removable from the sonde housing 560, allowing access to the electronics and components housed within the sensor package 562. When attaching the sensor package 562 to the sonde housing 560, the tongue 566 is received by a groove 568 in the sensor housing 560, allowing the lip on the opposing end of the sensor package 562 to pivot into mating engagement with the sonde housing 560. A bolt 564 is screwed into the bolt hole 565, which secures the sensor package 562 to the sonde housing 560. A seal can be provided between the sensor package 562 and sonde housing 560 to protect the sensor electronics and components from ingress of soil and liquid.

FIG. 5D is a cross-sectional view of the sensor package 562 shown in FIG. 5C.

The sensor package 562 includes components of the EM sensor 502 or 503 previously described, including an antenna arrangement 501, a battery 532, and cross-bore detection electronics 505. In one embodiment, the sensor package 562 incorporates the EM sensor 502 shown in FIG. 5A. In this embodiment, the antenna arrangement 501 includes a transmit antenna 508, a receive antenna 518, and the electronics 505 shown in FIG. 5A. In another embodiment, the sensor package 562 incorporates the EM sensor 503 shown in FIG. 5B. In this embodiment, the antenna arrangement 501 includes a single antenna 508 and the electronics 505 shown in FIG. 5B.

In accordance with other embodiments, the sensor package 562 can further incorporate a transmitter 550 configured to facilitate locating of the sensor package 562 by an above-ground locator 501. The transmitter 550 can be configured to include a dipole antenna 552 and a signal source 554, as well as a microprocessor, controller or other logic device. According to some embodiments, the signal source 554 and dipole antenna 552 cooperate to generate a modulated electromagnetic signal (e.g., a modulated magnetic field) that emanates from the sensor package 562 and is received by antennas of the above-ground locator 501. In response to receiving the modulated EM signal from the transmitter 550, the locator 501 is configured to accurately locate the position and depth of the sensor package 562 and, therefore, the cutting tool proximate the sensor package 562. The sensor package 562 may include other sensors 556, such as a pitch sensor, a roll sensor and/or other sensors, data from which may be imposed on the modulated EM signal. The locator 501 can be configured to determine clock position, pitch, yaw, and depth of the drill string/cutting tool, in addition to location. The transmitter 550 may be implemented in accordance with the teachings of U.S. Pat. No. 5,767,678, which is incorporated herein by reference.

The cross-bore detection electronics 505 are preferably coupled to the transmitter 550 so that cross-bore detection signals output from the electronics 505 can be imposed on the modulated EM signal generated by the transmitter 555/dipole antenna 550. For example, the cross-bore detection electronics 505 can be configured to monitor for a cross-bore during a drilling operation (e.g., drilling a pilot bore or backreaming), during which time above-ground locating of the cutting tool is conducted by an operator of the locator 501. In the event a cross-bore is detected by the cross-bore detection electronics 505, an alert signal can be generated by the cross-bore detection electronics 505 and communicated to the transmitter 550. The alert signal can be imposed on the modulated EM signal generated by the transmitter 550 and received above-ground by the locator 501. According to this approach, the amount of extra data (e.g., cross-bore alert signal) transferred through the modulated EM signal generated by the transmitter 550 is kept to a minimum. The locator 501 can be configured to extract the cross-bore alert signal from the received modulated EM signal and produce an alarm (e.g., audible or visual) to alert the locator operator of a cross-bore.

In some embodiments, the locator 501 can communicate drill string/cutting tool position/orientation and cross-bore detection data to an HDD machine interface. The HDD machine operator may be alerted to detection of a cross-bore by an alarm (e.g., audible or visual). In response to detecting a cross-bore by the locator operator or the HDD machine operator, a cross-bore verification procedure may be initiated in which the drill string is moved backward and forward relative to the cross-bore zone. The forward and reverse lateral displacement of the drill string moves the EM sensor 502/503 into and out of the cross-bore zone. If the drill string displacement into and out of the cross-bore zone results in generation of cross-bore detection signals, then an actual cross-bore event can be declared.

According to some embodiments, an alert signal generated by the cross-bore detection electronics 505 can be accompanied by or incorporate a confidence level indicator. The indicator can be a signal that indicates the level of confidence (e.g., high or low) that an actual cross-bore has been detected by the cross-bore detection electronics 505. For example, the indicator signal can have a first state which indicates that the cross-bore detection electronics 505 has detected an actual cross-bore with high confidence. The indicator signal can have a second state which indicates that the cross-bore detection electronics 505 has detected an actual cross-bore with low confidence. The indicator signal can be imposed on the modulated EM signal generated by the transmitter 550 in the form of a combined cross-bore detection alert/confidence signal or be transmitted as a separate signal in addition to the cross-bore detection alert signal. It is noted that the detailed data used by the cross-bore detection electronics 505 to generate the alert/confidence signal(s) can be stored in a memory of the sensor package 562 and retrieved from the memory in a manner previously described.

According to one embodiment, different thresholds, against which cross-bore detection signals are compared, can be associated with different levels of confidence that an actual cross-bore has been detected. For example, a 3 sigma threshold and a 6 signal threshold can be used to identify a cross-bore detection signal as being of low confidence or high confidence. If the change in the cross-bore detection signal processed by the cross-bore detection electronics 505 exceeds the 3 sigma threshold but not the 6 sigma threshold, the cross-bore detection signal is considered a low confidence signal. If the change in the cross-bore detection signal processed by the cross-bore detection electronics 505 exceeds the 6 sigma threshold, the cross-bore detection signal is considered a high confidence signal. If the change in the cross-bore detection signal processed by the cross-bore detection electronics 505 fails to exceed the 3 sigma threshold, no alert signal is generated by the cross-bore detection electronics 505.

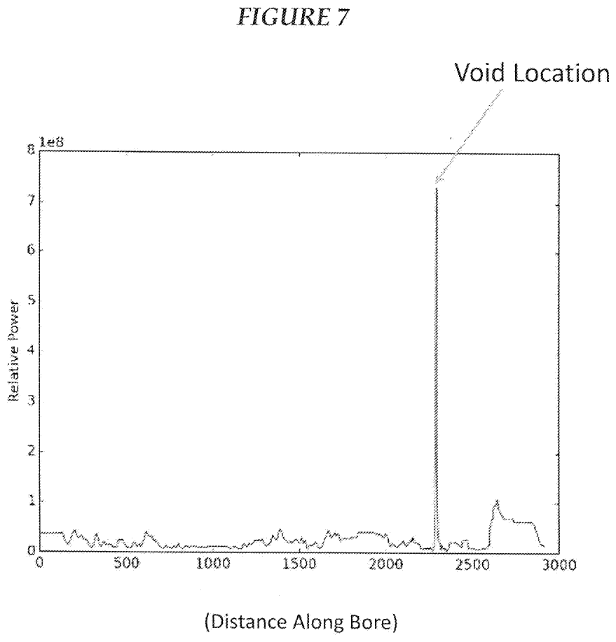

FIG. 7 is a graph showing detection of an underground void using an EM sensing technique of the present disclosure. In a field experiment, an air-filled void was created underground. A drill head having an EM sensing capability was displaced (no head rotation) by an HDD machine so as to penetrate the void. Coupled antenna power was monitored during displacement of the drill head. The data of FIG. 7 shows a large change in coupled antenna power in response to detecting the void.

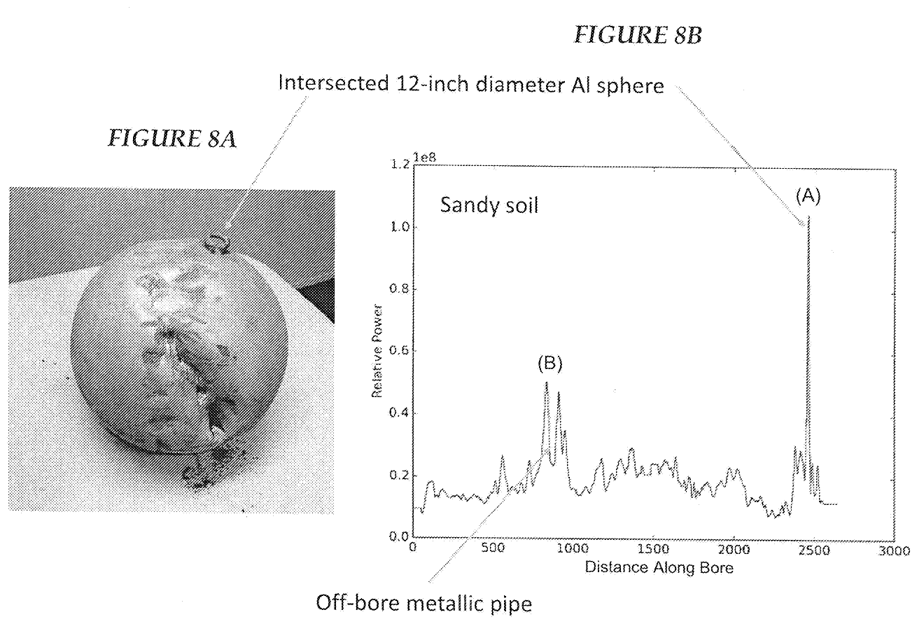

In another field experiment, and with reference to FIGS. 8A and 8B, a hollow 12-inch diameter aluminum sphere (FIG. 8A) was buried in sandy soil, and a drill head equipped with an EM sensing capability was advanced (no head rotation) through the sandy soil toward the sphere. Coupled antenna power was monitored during displacement of the drill head. The data of FIG. 8B shows a large change in coupled antenna power in response to penetrating the sphere. FIG. 8B also shows a moderate change in coupled antenna power in response to detecting near contact between the drill head and a metallic pipe prior to penetrating the sphere.

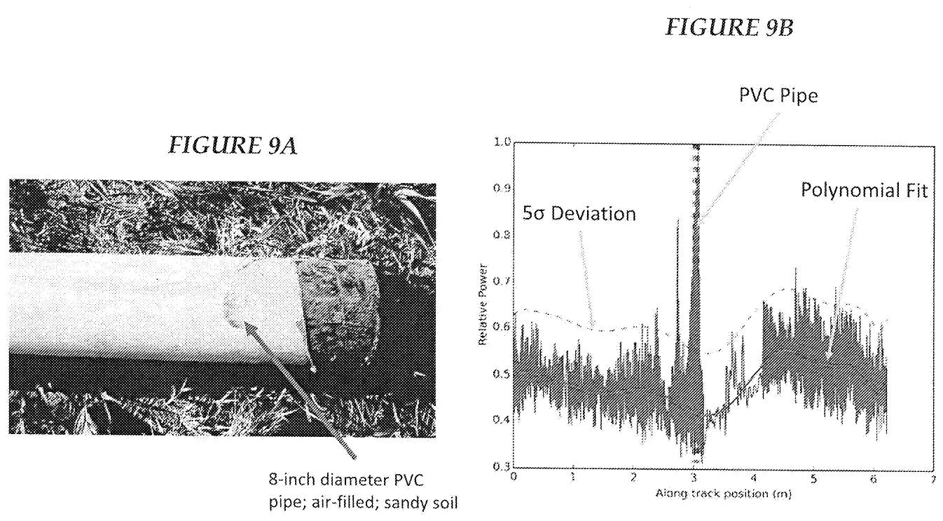

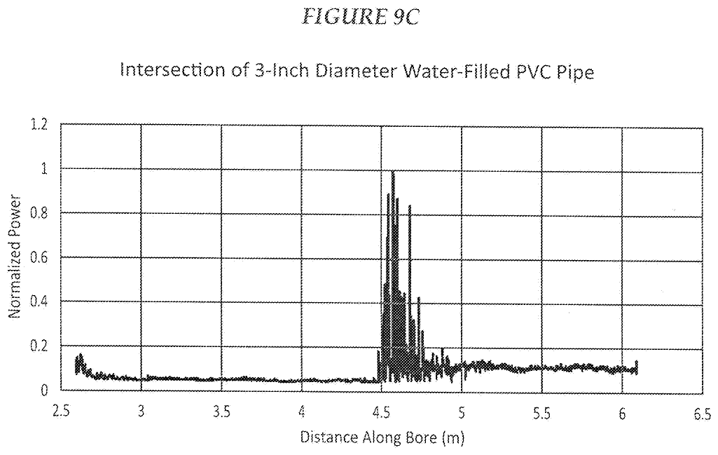

In a further field experiment, and with reference to FIGS. 9A and 9B, an 8-inch diameter PVC air-filled pipe (FIG. 9A) was buried in sandy soil, and a drill head equipped with an EM sensing capability was advanced (with head rotation) through the sandy soil toward the pipe. Coupled antenna power was monitored during displacement of the drill head. The data of FIG. 9B shows a large change (at the 3 m location) in coupled antenna power in response to striking, but not penetrating, the pipe. The graph of FIG. 9B also show a curve fitted (polynomial fit) to the coupled antenna power data. A dashed curve above the data curve represents a threshold (e.g., a 5 sigma variation) that can be used to detect contact with and/or penetration of the pipe with high confidence.

In another field experiment, and with reference to FIG. 9C, a 3-inch diameter water-filled PVC pipe was buried in heavy damp clay, and a drill head equipped with an EM sensing capability was advanced (with head rotation) toward the pipe. The EM attenuation was measured at >−150 dB/m. Coupled antenna power was monitored during displacement of the drill head. The data of FIG. 9C shows a large change in coupled antenna power at about 4.6 m in response to penetrating the pipe. FIGS. 7-9C demonstrate that an EM sensor configured to monitor coupled antenna power according to embodiments of the disclosure can readily detect penetration of a utility containing different media (e.g., air, water, gas) by a drill head displaced in disparate types of soil.

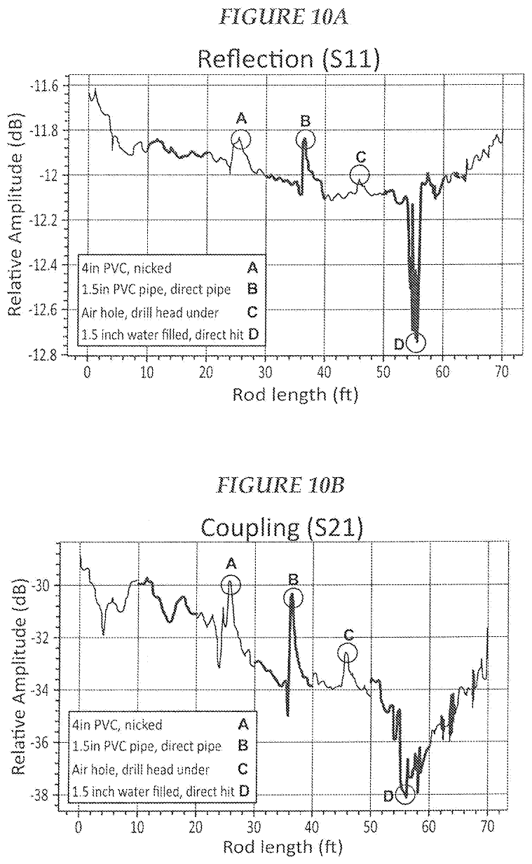

Additional field experimentation was performed using multiple underground targets filled with air and with water. A drill head equipped with an EM sensor was advanced along a pre-existing bore into which a number of vertical pipes were installed via auger holes that hit the bore. The targets included a 2-inch PVC pipe, two 1.5-inch PVC pipes, and a 4-inch PVC drain line. One of the 1.5 inch PVC pipes was air filled, while the other 1.5 inch PVC pipe was filled with water. The EM sensor transmitted a sequence of single-frequency pulses and measured the S11 (reflection) and S21 (coupling) signal for each pulse. Thirty-two frequencies distributed between 500 MHz and 3 GHz were transmitted and the resulting S-parameters were summed. The resulting S11 and S21 data were plotted, which is shown in FIGS. 10A (S11 reflection) and 10B (S21 coupling).

The data shown in FIGS. 10A and 10B are the results for a bore that nicked the 4-inch diameter air-filled PVC pipe (dot A), directly intersected the 1.5-inch diameter air-filled PVC pipe (dot B), passed just below an air-filled void (passing in the loose soil at the bottom of a post-hole) (dot C), and directly hit the 1.5-inch diameter water-filled PVC pipe (dot D). The plots shown in FIGS. 10A and 10B were from the same run, and represent data collected simultaneously. The spatial locations of each pipe/target are indicated by dots A-D. Each pipe intersection or near miss resulted in a signal that can be readily distinguished from background. The presence of a cross-bore or near miss for a PVC pipe or air-filled void can be unambiguously detected by the EM sensor, which allows for detection using an automatic target picking algorithm.

Notably, the data of FIGS. 10A and 10B show another interesting feature. All the air-filled pipes (dots A and B) show an increase in both the reflection and direct coupling signals, while the water-filled pipe (dot D) shows a rapid onset decrease in both. In other words, the polarity of the S11 and S21 signals for air-filled targets is opposite the polarity of the S11 and S21 signals for water-filled targets. As such, the EM sensor can be used to provide information on the type of material filling the target/pipe that is intersected (e.g., identify the type of material filling). For example, the polarity of the S11 and/or S21 signals produced by the EM sensor can be used by a detector or processor to distinguish between pipes filled with air and pipes filled with water.

Additional field experiments have demonstrated that the EM sensor can be used to detect a cross-bore with a metallic or non-metallic utility, detect a nick or brush-by with a metallic or non-metallic utility, and perform the detection in any soil type. By examining the S11 and S21 response characteristics, the EM sensor can provide information on the fill contents of a hollow pipe. The EM sensor can also be used to detect a cross-bore, nick, or brush-by of a solid metallic or non-metallic utility. The EM sensor can be used to detect a cross-bore, nick, or brush-by of a tree root. By logging the distance moved by the HDD carriage, for example, a distance along a bore where these events occurred can be determined. A system that incorporates an EM sensor can be designed so that communications and data download from the EM sensor and HDD mounted encoder box can be performed either wirelessly (WIFI®, Bluetooth®, etc.), wireline, or inductive signal transmittal (up the drill string).

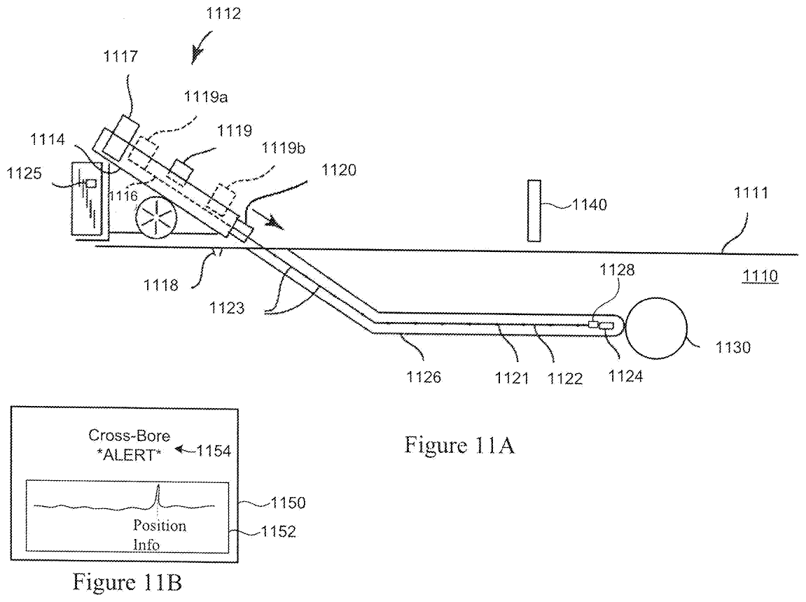

FIG. 11A shows a cross-section through a portion of ground where a boring operation takes place using an HDD machine equipped with an EM sensor configured to detect contact with and/or penetration of an underground utility (e.g., a cross-bore) according to various embodiments. The underground boring system, generally shown as the HDD machine 1112, is situated above ground 1111 and includes a platform 1114 on which is situated a tilted longitudinal member 1116. The platform 1114 is secured to the ground by pins 1118 or other restraining members in order to resist movement of the platform 1114 during the boring operation. Located on the longitudinal member 1116 is a thrust/pullback pump 1117 for driving (i.e., displacing) a drill string 1122 in a forward, longitudinal direction as generally shown by the arrow. The thrust/pullback pump 1117 is also configured to displace the drill string 1122 in the opposite direction indicated, such as during a backreaming operation. The drill string 1122 is made up of a number of drill string members or pipes 1123 attached end-to-end. Also located on the tilted longitudinal member 1116, and mounted to permit movement along the longitudinal member 1116, is a rotation motor or pump 1119 for rotating the drill string 1122 (illustrated in an intermediate position between an upper position 1119a and a lower position 1119b). In operation, the rotation motor 1119 rotates the drill string 1122 which has a cutting tool 1124 attached at the distal end of the drill string 1122.

A typical boring operation can take place as follows. The rotation motor 1119 is initially positioned in an upper location 1119a and rotates the drill string 1122. While the cutting tool 1124 is rotated through rotation of the drill string 1122, the rotation motor 1119 and drill string 1122 are pushed in a forward direction by the thrust/pullback pump 1117 toward a lower position into the ground, thus creating a borehole 1126. The rotation motor 1119 reaches a lower position 1119b when the drill string 1122 has been pushed into the borehole 1126 by the length of one drill string member 1123. A new drill string member 1123 is then added to the drill string 1122 either manually or automatically, and the rotation motor 1119 is released and pulled back to the upper location 1119a. The rotation motor 1119 is used to thread the new drill string member 1123 to the drill string 1122, and the rotation/push process is repeated so as to force the newly lengthened drill string 1122 further into the ground, thereby extending the borehole 1126.

Commonly, water or other fluid is pumped through the drill string 1122 (referred to herein as mud) by use of a mud pump. If an air hammer is used, an air compressor is used to force air/foam through the drill string 1122. The mud or air/foam flows back up through the borehole 1126 to remove cuttings, dirt, and other debris and improve boring effectiveness and/or efficiency.

A directional steering capability is typically provided for controlling the direction of the cutting tool 1124, such that a desired direction can be imparted to the resulting borehole 1126. By these actions, and various combinations of these basic actions, a boring procedure can advance a cutting tool 1124 through soil, including advancing the cutting tool 1124 through a turn. Because HDD typically does not bore a hole very far from the surface of the ground, many belowground obstacles (e.g., sewers, electrical lines, building foundations, etc.) must be maneuvered around. As such, many boring tools are configured to allow the bore path to turn (e.g., left, right, higher, lower) to curve the bore path around underground obstacles. An EM sensor 1128 is deployed proximate the cutting tool 1124, such as in a sonde or sub adjacent the cutting tool 1124. The EM sensor 1128 is of a type and has functionality previously described. The cutting tool 1124 and EM sensor 1128 are shown advancing toward a buried utility 1130, such as sewer lateral or main.

In accordance with some embodiments, the HDD machine 1112 includes an encoder 1120 to monitor of the position of the cutting tool 1124. As the cutting tool 1124 is pushed into the ground, a cable plays out and advances the encoder 1120, providing the system software with a measure of the drill head location and triggering time-stamped location measurements at discrete distance intervals. In this manner, time-stamped cutting tool location data is generated by a processor 1125 of the HDD machine 1112.

As was discussed previously, the EM sensor 1128 generates time-stamped sensor data during drilling and backreaming operations. According to some embodiments, after the EM sensor 1128 emerges from the subsurface, data stored in the EM sensor 1128 is transferred to the processor 1125 of the HDD machine 1112. A wireless link can be established between the EM sensor 1128 and an above-ground transceiver 1140 (e.g., a portable locator used to manually locate the cutting tool 1124). The transceiver 1140 preferably transmits the EM sensor data to a receiver at the HDD machine 1112 for reception by the processor 1125. According to some embodiments, the EM sensor 1128 can communicate sensor data in near-real time to the processor 1125 via a conductor or transmission path established along the drill string 1122 (e.g., through coupled conductors running through the drill string members 1123).

The processor 1125 can be coupled to a display 1150 (see FIG. 11B) of the HDD machine 1112 which is viewable by an operator. In other embodiments, the EM sensor data can be transmitted from the transceiver 1140 to a laptop, tablet or smartphone (which includes the display 1150). The processor 1125 cooperates with the display 1150 to present the EM sensor data in a data window 1152, which can display synchronized EM sensor and position data. In response to a detected cross-bore or utility strike (e.g., contact with or penetration of utility 1130), an alert 1154 can be presented on the display 1150, along with the position of the cross-bore or utility strike.

The discussion and illustrations provided herein are presented in an exemplary format, wherein selected embodiments are described and illustrated to present the various aspects of the present invention. Systems, devices, or methods according to the present invention may include one or more of the features, structures, methods, or combinations thereof described herein. For example, a device or system may be implemented to include one or more of the advantageous features and/or processes described below. A device or system according to the present invention may be implemented to include multiple features and/or aspects illustrated and/or discussed in separate examples and/or illustrations. It is intended that such a device or system need not include all of the features described herein, but may be implemented to include selected features that provide for useful structures, systems, and/or functionality.

Although only examples of certain functions may be described as being performed by circuitry for the sake of brevity, any of the functions, methods, and techniques can be performed using circuitry and methods described herein, as would be understood by one of ordinary skill in the art.

Systems, devices or methods disclosed herein may include one or more of the features structures, methods, or combination thereof described herein. For example, a device or method may be implemented to include one or more of the features and/or processes above. It is intended that such device or method need not include all of the features and/or processes described herein, but may be implemented to include selected features and/or processes that provide useful structures and/or functionality. Various modifications and additions can be made to the disclosed embodiments discussed above. Accordingly, the scope of the present disclosure should not be limited by the particular embodiments described above, but should be defined only by the claims set forth below and equivalents thereof.

1-44. (canceled)

45. An apparatus, comprising:
a downhole tool configured to support an electromagnetic sensor, the sensor comprising:
a housing having an exterior surface which is exposed to soil when the downhole tool moves through the soil;
a signal generator configured to generate a transmit signal;
an antenna arrangement supported by the housing and comprising at least one transmit antenna coupled to the signal generator and at least one receive antenna; and
a detector disposed in the housing and coupled to the signal generator and the transmit and receive antennas, the detector configured to:
measure a performance characteristic of the antenna arrangement indicative of power coupled between the transmit and receive antennas relative to a parameter of the transmit signal generated by the signal generator; and
detect a change in the antenna performance characteristic relative to a threshold indicative of contact between the apparatus and a buried utility.

46. The apparatus of claim 45, wherein the detector is configured to measure the performance characteristic independent of the signal generator by measuring the performance characteristic relative to the parameter of the transmit signal.

47. The apparatus of claim 45, wherein the detector is configured to remove effects of variation of signal generator power by measuring the performance characteristic relative to the parameter of the transmit signal.

48. The apparatus of claim 45, wherein:
the detector comprises:
a first detector coupled to the transmit antenna; and
a second detector coupled to the receive antenna; and
at least one of the first detector and the second detector is coupled to the signal generator.

49. The apparatus of claim 45, wherein:
the detector comprises:
a first power detector coupled to the transmit antenna; and
a second power detector coupled to the receive antenna; and
at least one of the first power detector and the second power detector is coupled to the signal generator.

50. The apparatus of claim 45, wherein the antenna arrangement comprises a plurality of receive antennas.

51. The apparatus of claim 50, wherein the plurality of receive antennas are distributed about a periphery of the housing.

52. The apparatus of claim 45, wherein the detector is configured to:
measure a parameter of reflected power from at least one of the transmit and receive antennas; and
detect that the apparatus has contacted the buried utility in response to comparing the measured performance characteristic to a first threshold and comparing the measured reflected power to a second threshold.

53. The apparatus of claim 45, wherein the detector is configured to:
acquire information from one or more other sensors or information sources while moving the downhole tool through the soil; and
integrate the performance characteristic measurement with the acquired information to increase the confidence of detecting actual contact between the apparatus and the buried utility.

54. The apparatus of claim 45, wherein the detector is configured to identify a type of material filling the buried utility using a change in the antenna performance characteristic.

55. An apparatus, comprising:
a downhole tool configured to support an electromagnetic sensor, the sensor comprising:
a housing having an exterior surface which is exposed to soil when the downhole tool moves through the soil;
a signal generator configured to generate a transmit signal;
an antenna arrangement supported by the housing and comprising at least one transmit antenna coupled to the signal generator and at least one receive antenna; and
a detector disposed in the housing and coupled to the signal generator and the transmit and receive antennas, the detector configured to:
measure coupling between the transmit and receive antennas relative to a parameter of the transmit signal generated by the signal generator; and
detect that the apparatus has contacted a buried utility in response to comparing the measured coupling to a threshold.

56. The apparatus of claim 55, wherein the detector is configured to measure coupling between the transmit and receive antennas independent of the signal generator by measuring coupling between the transmit and receive antennas relative to the parameter of the transmit signal.

57. The apparatus of claim 55, wherein the detector is configured to remove effects of variation of signal generator power by measuring coupling between the transmit and receive antennas relative to the parameter of the transmit signal.

58. The apparatus of claim 55, wherein:
the detector comprises:
a first detector coupled to the transmit antenna; and
a second detector coupled to the receive antenna; and
at least one of the first detector and the second detector is coupled to the signal generator.

59. The apparatus of claim 55, wherein:
the detector comprises:
a first power detector coupled to the transmit antenna; and
a second power detector coupled to the receive antenna; and
at least one of the first power detector and the second power detector is coupled to the signal generator.

60. The apparatus of claim 55, wherein the antenna arrangement comprises a plurality of receive antennas.

61. The apparatus of claim 60, wherein the plurality of receive antennas are distributed about a periphery of the housing.

62. The apparatus of claim 55, wherein the detector is configured to:
measure a parameter of reflected power from at least one of the transmit and receive antennas; and
detect that the apparatus has contacted the buried utility in response to comparing the measured coupling to a first threshold and comparing the measured reflected power to a second threshold.

63. The apparatus of claim 55, wherein the detector is configured to:
acquire information from one or more other sensors or information sources while moving the downhole tool through the soil; and
integrate the coupling measurement with the acquired information to increase the confidence of detecting actual contact between the apparatus and the buried utility.

64. The apparatus of claim 55, wherein the detector is configured to identify a type of material filling the buried utility using a change of coupling measurements.

65. A method, comprising:
moving a drill string through soil, the drill string having a distal end coupled to a downhole tool comprising an electromagnetic sensor, the sensor comprising a signal generator configured to generate a transmit signal, an antenna arrangement comprising at least one transmit antenna coupled to the signal generator and at least one receive antenna, and a detector coupled to the signal generator and the transmit and receive antennas;
transmitting a signal from the transmit antenna into soil surrounding the downhole tool;
measuring, using the detector, a performance characteristic of the antenna arrangement indicative of power coupled between the transmit and receive antennas relative to a parameter of the transmit signal generated by the signal generator; and
detecting a change in the antenna performance characteristic relative to a threshold indicative of contact between the drill string and a buried utility.

66. The method of claim 65, wherein:
measuring the performance characteristic of the antenna arrangement comprises measuring coupling between the transmit and receive antennas relative to the parameter of the transmit signal; and
detecting the change in the antenna performance characteristic comprises comparing the measured coupling to the threshold indicative of contact between the drill string and the buried utility.

67. The method of claim 65, further comprising generating an alert perceivable by an operator in response to detecting contact between the drill string and the buried utility.
